(19) United States
(12) Patent Application Publication
(10) Pub. No.: US 2017/0276998 A1
(43) Pub. Date: Sep. 28, 2017

(54) POLARIZED DEVICES AND DISPLAY DEVICES

(71) Applicant: Shenzhen China Star Optoelectronics Technology Co., Ltd., Shenzhen, Guangdong (CN)

(72) Inventor: Bo HAI, Shenzhen, Guangdong (CN)

(73) Assignee: Shenzhen China Star Optoelectronics Technology Co., Ltd., Shenzhen, Guangdong (CN)

(21) Appl. No.: 14/909,787

(22) PCT Filed: Jan. 5, 2016
(86) PCT No.: PCT/CN2016/070153

§ 371 Date: Feb. 3, 2016

(30) Foreign Application Priority Data
Dec. 1, 2015 (CN) 201510870233.1

(51) Int. Cl. G02F 1/1335; G02F 1/13363

(52) U.S. Cl. CPC G02F 1/133528; G02F 1/13363; G02F 2413/01; G02F 2001/133531; G02F 2413/05

(57) ABSTRACT

A polarized device includes a first polarizer, a second polarizer, and a compensation film between the first polarizer and the second polarizer. An absorption axis of the first polarizer is vertical to the absorption axis of the second polarizer, and a slow axis of the compensation film is vertical to the absorption axis of the first polarizer or the absorption axis of the second polarizer. In addition, a display device incorporated with the polarized device is disclosed. The polarized device and the display device may greatly eliminate the optical leakage when the polarizers are not orthogonal to each other such that the display performance may be enhanced.

### BACKGROUND OF THE INVENTION

1. Field of the Invention

The present disclosure relates to optical technology, and more particularly to a polarized device and a display device having the polarized device.

2. Discussion of the Related Art

Polarizers may absorb light beams having a polarized direction vertical to a polarization axis such that only the light beams having the polarized direction parallel to the polarization axis may pass through. Nowadays, the polarizers have been widely adopted in the display devices and radiating devices. Generally, the polarized devices include two polarizers overlapped together. When viewing in front of the device, the absorption axes of the two polarizers are vertical to each other. Thus, the polarized device may completely absorb the incident lights such that the polarized device is in a dark state. However, when viewing from a lateral side, the absorption axes of the two polarizers are not vertical to each other, and optical leakage may occur, and the display performance may be greatly affected.

### SUMMARY

In order to over the above problems, it is necessary to provide a polarized device and the display device having the same to enhance the optical leakage when viewing from the lateral side of the display device.

In one aspect, a polarized device includes: a first polarizer, a second polarizer, and a compensation film between the first polarizer and the second polarizer, wherein: an absorption axis of the first polarizer is vertical to the absorption axis of the second polarizer, and a slow axis of the compensation film is vertical to the absorption axis of the first polarizer or the absorption axis of the second polarizer.

Wherein the first polarizer and the second polarizer are made by PVA.

Wherein the compensation film is made by any one of Triacetyl Cellulose (TAC), Cyclo-olefin Polymer (COP), Polycarbonate (PC).

Wherein a compensation value (Ro) of the compensation film is in a range between 0 and 528 nm, and Ro represents an in-plane optical path difference generated when light beams pass through the compensation film.

Wherein the compensation value of the compensation film (Ro) is 264 nm.

Wherein the compensation value (Rth) of the polarized device is zero, and Rth represents an optical path difference along a vertical direction when the light beams pass through the compensation film.

In another aspect, a display device includes: a polarized device including a first polarizer, a second polarizer, and a compensation film between the first polarizer and the second polarizer, wherein: an absorption axis of the first polarizer is vertical to the absorption axis of the second polarizer, and a slow axis of the compensation film is vertical to the absorption axis of the first polarizer or the absorption axis of the second polarizer.

Wherein the display device comprises a liquid crystal display unit arranged between the first polarizer and the second polarizer.

Wherein: the liquid crystal display unit is arranged between the first polarizer and the compensation film, and the slow axis of the compensation film is vertical to the absorption axis of the second polarizer; or the liquid crystal display unit is arranged between the second polarizer and the compensation film, and the slow axis of the compensation film is vertical to the absorption axis of the first polarizer.

Wherein the liquid crystal display unit is an IPS, VA or TN display unit.

The polarized device and the display device having the polarized device may greatly eliminate the optical leakage when the polarizers are not orthogonal to each other such that the display performance may be enhanced.

### BRIEF DESCRIPTION OF THE DRAWINGS

FIG. 1 is a schematic view of the polarized device in accordance with one embodiment.

FIG. 2 is a schematic view of the display device having the polarized device of FIG. 1 in accordance with a first embodiment.

FIG. 3 is a schematic view of the display device having the polarized device of FIG. 1 in accordance with a second embodiment.

FIG. 4 is a curve diagram showing the relationship between the maximum value of the optical leakage and the compensation value with respect to a side view.

FIG. 5 is a curve diagram showing the relationship between the maximum value of the optical leakage and the compensation value when the azimuthal angle is 40 degrees.

FIG. 6 is a curve diagram showing the relationship between the ratio of the optical leakage to the center view and the compensation value when the azimuthal angle is 40 degrees.

### DETAILED DESCRIPTION OF THE EMBODIMENTS

Embodiments of the invention will now be described more fully hereinafter with reference to the accompanying drawings, in which embodiments of the invention are shown.

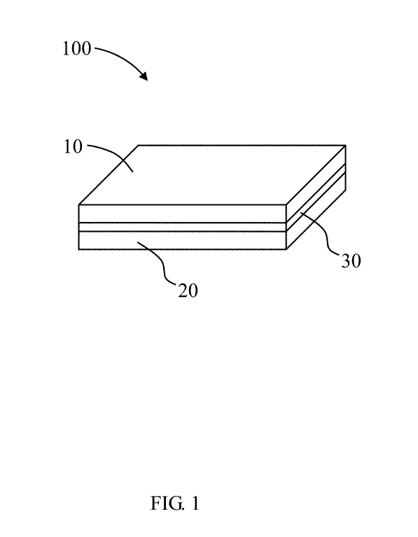

As shown in FIG. 1, the polarized device 100 includes a first polarizer 10, a second polarizer 20, and a compensation film 30 between the first polarizer 10 and the second polarizer 20.

The absorption axis of the first polarizer 10 is vertical to the absorption axis of the second polarizer 20. The first polarizer 10 and the second polarizer 20 may be made by the same material or different material. In the embodiment, the first polarizer 10 and the second polarizer 20 are made by the same material, i.e., PVA.

In the embodiment, the first polarizer 10 is arranged at a light incident side, and the second polarizer 20 is arranged at a light emitting side. (it can be understood that the first polarizer 10 may be arranged at the light emitting side, and the second polarizer 20 may be arranged at the light incident side.

The compensation film 30 may reduce or eliminate the optical leakage of the polarized device 100 for the side view. A slow axis of the compensation film 30 is vertical to one of the absorption axis of the first polarizer 10 and the second polarizer 20. The compensation film 30 may be made by one of the Triacetyl Cellulose (TAC), Cyclo-olefin Polymer (COP), Polycarbonate (PC) or a combination of the above. The compensation value of the compensation film 30 (Ro) is in a range between 0 and 528 nm, Rth is zero, Ro represents an in-plane optical path difference when light beams pass through the compensation film 30, Rth represents an optical path difference along a vertical direction when light beams pass through the compensation film 30, and the compensation value Ro and Rth may be obtained by the equation below:

Ro=(Nx−Ny)*d;

Rth=[(Nx+Ny)/2−Nz]*d;

Wherein Nx, Ny represents an in-plane reflective index of the compensation film 30 along a horizontal direction, Nz is a vertical reflective index of the compensation film 30 along a vertical direction, and d is the thickness of the compensation film 30.

Preferably, the compensation value of the compensation film 30 (Ro) is 264 nm. With such configuration, the compensation film 30 may greatly eliminate the optical leakage of the polarized device 100 for the side view.

The polarized device 100 may be adopted in display devices, radiating devices, and other devices.

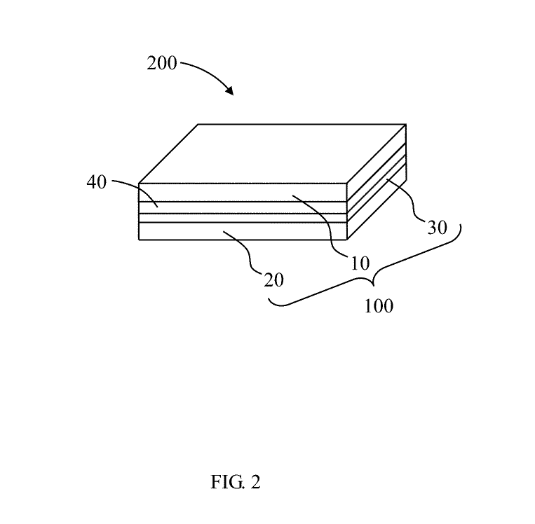

Referring to FIG. 2, a display device 200 includes the polarized device 100 of FIG. 1. In addition to the polarized device 100, the display device 200 further includes a liquid crystal display unit 40 arranged between the first polarizer 10 and the compensation film 30. The slow axis is vertical to the absorption axis of the second polarizer 20.

The liquid crystal display unit 40 may be of a variety of types, such as IPS, VA, or TN. In the embodiment, the liquid crystal display unit 40 is a IPS liquid crystal display unit.

The display device 200 including the polarized device 100 may greatly enhance the optical leakage issue when viewing from the lateral side of the display device.

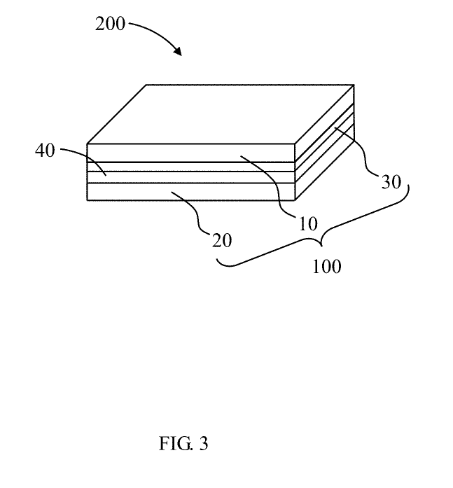

FIG. 3 is a schematic view of the display device having the polarized device of FIG. 1 in accordance with a second embodiment. The structure of the display device 300 is similar to that of the display device 200 of FIG. 2. The liquid crystal display unit 50 of the display device 300 is arranged between the compensation film 30 and the second polarizer 20. In the embodiment, the slow axis of the compensation film 30 is vertical to the absorption axis of the first polarizer 10. The display device 300 may achieve similar display performance of the display device 200 of FIG. 2.

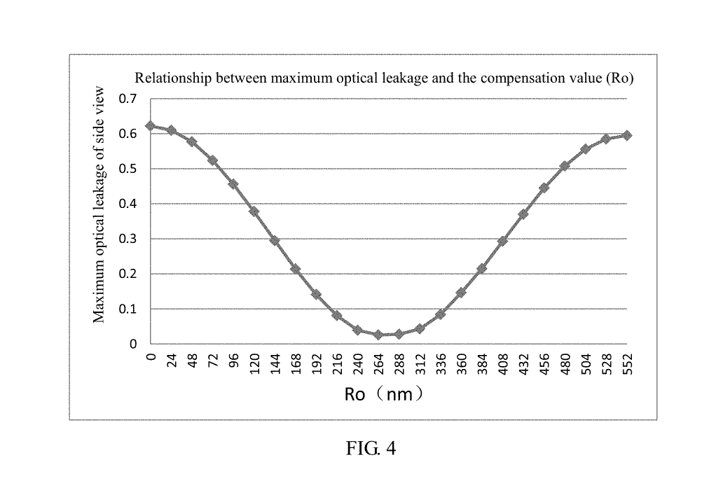

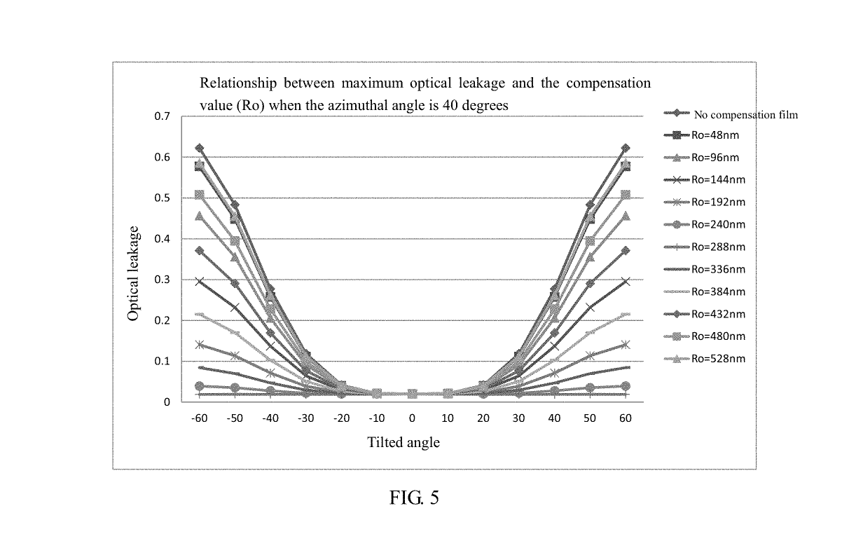

Referring to FIGS. 4-6, the curve diagrams show the simulation results of the optical leakage of the polarized device 100. The simulations are conducted by adopting Blue-YAG LED optical spectrum, and a central brightness of the light source is 100 nit, the distribution of the light source is similar to Lambert's distribution, the compensation value (Rth) is zero. A variety of compensation value (Ro) are adopted to simulate the optical leakage of the polarized device 100, wherein the compensation value (Ro) is in the range between 0 and 528 nm. FIG. 4 is a curve diagram showing the relationship between the maximum value of the optical leakage and the compensation value with respect to a side view. FIG. 5 is a curve diagram showing the relationship between the maximum value of the optical leakage and the compensation value when the azimuthal angle is 40 degrees.

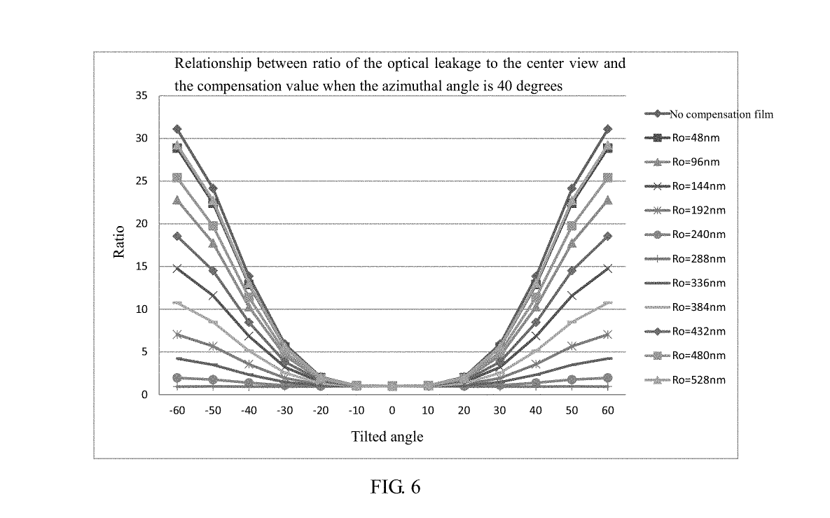

FIG. 6 is a curve diagram showing the relationship between the ratio of the optical leakage to the center view and the compensation value when the azimuthal angle is 40 degrees.

In view of the simulation result, the optical leakage of the polarized device 100 may be enhanced when Ro is in the range between 240 and 310 nm, the optical leakage is minimum when Ro equals to 264 nm.

The polarized device and the display device having the same may greatly eliminate the optical leakage when the polarizers are not orthogonal to each other for the side view. As such, the display performance may be enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A polarized device, comprising:
a first polarizer, a second polarizer, and a compensation film between the first polarizer and the second polarizer, wherein:
an absorption axis of the first polarizer is vertical to the absorption axis of the second polarizer, and a slow axis of the compensation film is vertical to the absorption axis of the first polarizer or the absorption axis of the second polarizer.

2. The polarized device as claimed in claim 1, wherein the first polarizer and the second polarizer are made by PVA.

3. The polarized device as claimed in claim 1, wherein the compensation film is made by any one of Triacetyl Cellulose (TAC), Cyclo-olefin Polymer (COP), Polycarbonate (PC).

4. The polarized device as claimed in claim 1, wherein a compensation value (Ro) of the compensation film is in a range between 0 and 528 nm, and Ro represents an in-plane optical path difference generated when light beams pass through the compensation film.

5. The polarized device as claimed in claim 4, wherein the compensation value of the compensation film (Ro) is 264 nm.

6. The polarized device as claimed in claim 4, wherein the compensation value (Rth) of the polarized device is zero, and Rth represents an optical path difference along a vertical direction when the light beams pass through the compensation film.

7. A display device, comprising:
A polarized device comprising a first polarizer, a second polarizer, and a compensation film between the first polarizer and the second polarizer, wherein:
an absorption axis of the first polarizer is vertical to the absorption axis of the second polarizer, and a slow axis of the compensation film is vertical to the absorption axis of the first polarizer or the absorption axis of the second polarizer.

8. The display device as claimed in claim 7, wherein the display device comprises a liquid crystal display unit arranged between the first polarizer and the second polarizer.

9. The display device as claimed in claim 7, wherein:
the liquid crystal display unit is arranged between the first polarizer and the compensation film, and the slow axis of the compensation film is vertical to the absorption axis of the second polarizer; or
the liquid crystal display unit is arranged between the second polarizer and the compensation film, and the slow axis of the compensation film is vertical to the absorption axis of the first polarizer.

10. The display device as claimed in claim 7, wherein the liquid crystal display unit is an IPS, VA or TN display unit.

11. The display device as claimed in claim 7, wherein the first polarizer and the second polarizer are made by PVA.

12. The display device as claimed in claim 7, wherein the compensation film is made by any one of Triacetyl Cellulose (TAC), Cyclo-olefin Polymer (COP), Polycarbonate (PC).

13. The display device as claimed in claim 7, wherein a compensation value (Ro) of the compensation film is in a range between 0 and 528 nm, and Ro represents an in-plane optical path difference generated when light beams pass through the compensation film.

14. The display device as claimed in claim 13, wherein the compensation value of the compensation film (Ro) is 264 nm.

15. The display device as claimed in claim 13, wherein the compensation value (Rth) of the polarized device is zero, and Rth represents an optical path difference along a vertical direction when the light beams pass through the compensation film.
